(19) United States
(12) Patent Application Publication
(10) Pub. No.: US 2010/0262484 A1
(43) Pub. Date: Oct. 14, 2010

(54) INTEGRATED CAMPAIGN PERFORMANCE REPORTING AND MANAGEMENT

(75) Inventors: Ariel H. Bardin, Belmont, CA (US); Thomas R. Stanis, Saratoga, CA (US); Ye-Jeong Kim, Menlo Park, CA (US); Julie A. Black, Menlo Park, CA (US); Jason C. Miller, San Francisco, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/544,564

(22) Filed: Aug. 20, 2009

Related U.S. Application Data
(60) Provisional application No. 61/167,706, filed on Apr. 8, 2009.

(51) Int. Cl. G06Q 30/00; G06Q 10/00

(52) U.S. Cl. 705/14.41

(57) ABSTRACT

Systems and methods for integrated campaign management interfaces for online advertisements. A campaign management interface facilitates review of advertising placements (e.g., websites) and keywords, as well as provide a detailed analysis of subgroups (e.g., webpages within a website) in a single interface.

This application claims the benefit under 35 U.S.C. §119(e) of U.S. Patent Application No. 61/167,706, titled “Integrated Campaign Performance Reporting And Management,” filed Apr. 8, 2009, which is incorporated herein by reference.

### BACKGROUND

This disclosure is related to advertisement buying and selling exchanges.

The Internet has enables access to a wide variety of content items, e.g., video and/or audio files, web pages for particular subjects, news articles, etc. Such access to these content items has likewise enabled opportunities for targeted advertising. For example, content items of particular interest to a user can be identified by a search engine in response to a user query. The query can include one or more search terms, and the search engine can identify and, optionally, rank the content items based on the search terms in the query and present the content items to the user (e.g., according to the rank). This query can also be an indicator of the type of information of interest to the user. By comparing the user query to a list of keywords specified by an advertiser, it is possible to provide targeted advertisements to the user.

Another form of online advertising is advertisement syndication in a content network of publishers. This syndication allows advertisers to extend their marketing reach by distributing advertisements to additional partners. For example, third party online publishers can place an advertiser's text or image advertisements on web pages that have content related to the advertisement. As the users are likely interested in the particular content on the publisher webpage, they are also likely to be interested in the product or service featured in the advertisement. Accordingly, such targeted advertisement placement can help drive online customers to the advertiser's website.

Advertisers often create advertising campaigns, which are a series of advertisements that share common ideas or themes, for online advertising. When utilizing an online advertising campaign, the advertisers manage their campaign by use of a campaign management tool. The campaign management tool provides a user interface through which the advertisers can specify advertising budgets for advertisements; when, where and under what conditions particular advertisements may be served for presentation; and bids for various types of advertisement events, such as impressions and/or clicks.

Advertisers can monitor their campaigns by generating a performance placement report using a reporting tool that is separate from the campaign management tool. The advertiser can review the various placements and determine whether to make any changes to the campaign. If the advertiser would like make changes to their advertising campaign, the campaign can be modified through the separate campaign management tool.

### SUMMARY

Systems, methods and computer readable media for integrated campaign reporting and management are provided. In an aspect, an example method for integrated campaign performance reporting and management can include: providing campaign management interface data that causes a user device to display a campaign management interface, the campaign management interface comprising a plurality of rows, each of the rows corresponding to a placement specified in an advertising campaign, the rows having a plurality of fields, the campaign management interface being operable to display performance data associated with each placement and to display campaign data associated with a campaign in the plurality of fields and facilitate editing of the campaign data; receiving a request to provide placement report data for a selected placement, the placement report data specifying the campaign performance of the placement according to a plurality of subgroups, each subgroup belonging to the selected placement, and which causes the user device to display a placement within the campaign management interface, the placement report comprising a plurality of rows, each row corresponding to a subgroup and having a plurality of fields in which performance data corresponding to only that subgroup is displayed; generating the placement report data; and providing the placement report data to the user device. Other implementations are disclosed, including implementations directed to systems, methods, apparatuses, computer-readable mediums and user interfaces.

In anther aspect, an example method for integrated campaign performance reporting and management can include: receiving campaign management interface data at a user device, the campaign management interface data operable to cause the user device to display a campaign management interface, the campaign management interface comprising a plurality of rows, each of the rows corresponding to a placement specified in an advertising campaign, the rows having a plurality of fields, the campaign management interface being operable to display performance data associated with each placement and to display campaign data associated with a campaign in the plurality of fields and facilitate editing of the campaign data; displaying the campaign management interface at the user device; sending a request to an advertisement system from the user device, the request being a request to provide placement report data for a selected placement, the placement report data specifying the campaign performance of the placement according to a plurality of subgroups, each subgroup belonging to the selected placement, and which causes the user device to display a placement within the campaign management interface, the placement report comprising a plurality of rows, each row corresponding to a subgroup and having a plurality of fields in which performance data corresponding to only that subgroup is displayed; receiving the placement report data at the user device; and displaying the placement report at the user device. Other implementations are disclosed, including implementations directed to systems, methods, apparatuses, computer-readable mediums and user interfaces.

Particular embodiments of the subject matter described in this specification can be implemented to realize one or more of the following advantages. Performance reports for an advertising campaign can be integrated into an advertising campaign management interface, improving the workflow of campaign management and monitoring. Campaign data associated with a placement can be modified from a performance report environment, reducing the likelihood of errors occurring. A performance report can be generated in an overlay format, or can optionally be generated in-line within the campaign management interface. The advantages and features listed in the above list are optional and not exhaustive. The advantages and features can be separately realized or realized in various combinations.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a block diagram of an example network architecture that can provide bid adjustment based upon differential buying channels.

FIGS. 2A-D are screen shot representations of an example integrated campaign management interface.

FIGS. 3A-C are screen shot representations illustrating features of an integrated campaign management interface.

FIG. 4 is a flowchart of an example method for providing integrated campaign reporting and management.

FIG. 5 is block diagram of an example computer system.

### DETAILED DESCRIPTION

Integrated campaign performance reporting and management systems and methods are provided herein. Such systems and methods can provide an integrated campaign management interface. The integrated campaign management interface can facilitate review of advertising placements (e.g., websites) and keywords, as well as provide a detailed analysis of subgroups (e.g., webpages within a website) based upon input received from an advertiser. The integrated campaign management interface can further facilitate excluding of selected keywords, placements, or subgroups thereof, from consideration for participating in an auction for an advertising slot associated with the selected keywords, placements or subgroups thereof. The campaign management interface can also facilitate adding of selected keywords, placements, or subgroups thereof, to be considered for participation in an auction for an advertising slot associated with the selected keywords, placements, or subgroups thereof. In further implementations, the integrated campaign management interface can provide the ability to modify bids associated with selected keywords, placements, or subgroups thereof.

Although various examples are described with reference to advertisements, the systems and methods described in this specification can also facilitate the quality score adjustment of other types of content items having measurable performance or quality parameters, such as videos, articles, reviews, etc.

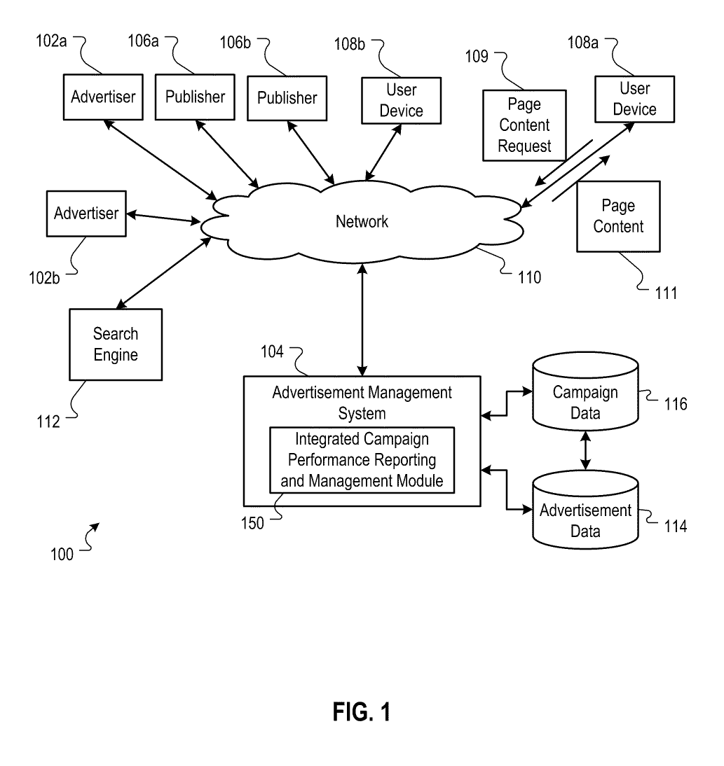

The subject matter of this specification can be implemented in an online environment, such as the example online environment 100 shown in FIG. 1. The online environment 100 can facilitate the identification and serving of content items, e.g., web pages, advertisements, etc., to users. A computer network 110, such as a local area network (LAN), wide area network (WAN), the Internet, or a combination thereof, connects advertisers 102a and 102b, an advertisement management system 104, publishers 106a and 106b, user devices 108a and 108b, and a search engine 112. Although only two advertisers (102a and 102b), two publishers (102a and 102b) and two user devices (108a and 108b) are shown, the online environment 100 may include many thousands of advertisers, publishers and user devices.

### § 1.0 Advertisement Publishing And Tracking

In the online environment 100, one or more advertisers 102a and/or 102b can directly, or indirectly, enter, maintain, and track online advertisement information in the advertising management system 104. The online advertisements can be in the form of graphical advertisements, such as banner advertisements, text only advertisements, image advertisements, audio advertisements, video advertisements, advertisements combining one of more of any of such components, etc., or any other type of electronic advertisement.

A user device, such as user device 108a , can submit a page content request 109 to a publisher 106 or the search engine 112 and receive page content 111 in return. The page content 111 can include advertisements provided by the advertisement management system 104, or can include executable instructions, e.g., JavaScript™, that can be executed at the user device 108a to request advertisements from the advertisement management system 104. Example user devices 108 include personal computers, mobile communication devices, television set-top boxes, etc.

Advertisements can also be provided from the publishers 106. For example, one or more publishers 106a and/or 106b can submit advertisement requests for one or more advertisements to the system 104. The system 104 responds by sending the advertisements to the requesting publisher 106a or 106b for placement on one or more of the publisher's web properties (e.g., websites and other network-distributed content). The advertisements can include embedding links landing pages, e.g., pages on the advertisers 102 websites that a user is directed to when the user clicks on an ad presented on a publisher website.

In some implementations, a publisher 106 can combine the requested content with one or more of the advertisements provided by the system 104. This combination of page content and advertisements can be sent to the user device 108 that requested the content (e.g., user device 108a) as page content 111 for presentation in a viewer (e.g., a browser or other content display system). The publisher 106 can transmit information about the advertisements back to the advertisement management system 104.

Publishers 106a and 106b can include general content servers that receive requests for content (e.g., articles, discussion threads, music, video, graphics, search results, web page listings, information feeds, etc.), and retrieves the requested content in response to the request. For example, content servers related news content providers, retailers, independent blogs, social network sites, or any other entity that provides content over the network 110 can be a publisher.

Advertisements can also be provided using the search engine 112. The search engine 112 can receive queries for search results. In response, the search engine 112 can retrieve relevant search results from an index of documents (e.g., from an index of web pages). Search results can include, for example, lists of web page titles, snippets of text extracted from those web pages, and hypertext links to those web pages, and may be grouped into a predetermined number of (e.g., ten) search results.

The search engine 112 can also submit a request for advertisements to the system 104. The request for advertisements can include the query (as entered or parsed), information based on the query (such as geo-location information, whether the query came from an affiliate and an identifier of such an affiliate), and/or information associated with, or based on, the search results, and the system 104 can provide relevant advertisements in response. The search engine 112 can combine the search results with one or more of the advertisements provided by the system 104. This combined information can then be forwarded to the user device 108 that requested the content as the page content 111.

The advertisers 102, user devices 108, and/or the search engine 112 can also provide usage information to the advertisement management system 104. This usage information can include measured or observed user behavior related to advertisements that have been served, such as, for example, whether or not a conversion or a selection related to an advertisement has occurred. The user behavior of selecting an advertisement can be referred to as an online response to the advertisement, e.g., a click-through. In some implementations, the system 104 can perform financial transactions, such as crediting the publishers 106 and charging the advertisers 102 based on the usage information. Such usage information can also be processed to measure performance metrics, such as a click-through rate (“CTR”), conversion rate, and other measurable performance metrics for online responses.

A click-through occurs when a user of a user device, selects or “clicks” on a link to a content item returned by the publisher or the advertising management system. The CTR is a performance metric that is obtained by dividing the number of users that clicked on the content item, e.g., a link to a landing page, an advertisement, or a search result, by the number of times the content item was delivered.

A “conversion” occurs when a user consummates a transaction related to a previously served advertisement. What constitutes a conversion may vary from case to case and can be determined in a variety of ways. For example, an online conversion may occur when a user clicks on an advertisement, is referred to the advertiser's web page, and consummates a purchase there before leaving that web page. Other actions that constitute a conversion can also be used.

In addition to the advertisements being selected based on content such as a search query or web page content of a publisher, the advertisements are also selected based on an auction process in the advertisement management system 104. The advertisers 102 are permitted to select, or bid, an amount they are willing to pay for each click of an advertisement, e.g., a cost-per-click amount an advertiser pays when, for example, a user clicks on an advertisement. The cost-per-click can include a maximum cost-per-click, e.g., the maximum amount the advertiser is willing to pay for each click of an advertisement based on a keyword.

The position, or rank, of an advertisement, such as where the advertisement is displayed next to search results or in which slot an advertisement will be displayed on a publisher page, can be a function of the cost-per-click multiplied by a quality score associated with the advertisement. A quality score can be the basis for measuring the quality and relevance of an advertisement. The quality score can, for example, be determined by the advertisement's click-through rate, the relevance of the advertisement text, overall historical keyword performance, and the user experience on a landing page associated with the advertisement. Other parameters can also be used to determine a quality score. The rank of an advertisement that is displayed can be determined by multiplying the maximum cost-per-click for the advertisement by a quality score of the advertisement. The advertisement can then be placed among other advertisements in order of increasing or decreasing rank.

An advertisement can also be associated with an actual cost-per-click. The actual cost-per-click of the advertisement can be determined by the maximum cost-per-click of the advertisement, quality score of the advertisement, and by the amount selected or bid by the advertiser directly below. In one implementation, the actual cost-per-click can be the price that is necessary to keep the advertisement's position above the next advertisement. To determine the actual cost-per-click, the system 104 can determine how much the advertiser in position 1 would have to pay to give it a rank equal to the advertiser in position 2, and then the system 104 adds a unit amount, e.g., $0.01, to this determined amount.

The advertisements, associated usage data, and bidding parameters described above can be stored as advertisement data in an advertisement data store 114. An advertiser 102 can further manage the serving of advertisements by specifying an advertising campaign. The data defining an advertising campaign can be stored in campaign data in a campaign data store 116, which can, for example, specify advertising budgets for advertisements, and when, where and under what conditions particular advertisements may be served for presentation, etc.

### § 2.0 Performance Placement Reports

The advertising management system 104 can also include an integrated campaign performance reporting and management module 150. The integrated campaign performance reporting and management module 150 facilitates presentation of an integrated campaign management interface by generating and providing campaign management interface data and placement report data to user devices. The campaign management interface data causes a user device to display a campaign management interface as described below, and the place report data causes the user device to display a performance placement report as described below.

The integrated campaign management interface provides integration of campaign reporting and management features so that the placement report can be provided within the campaign management interface. The integration of campaign reporting and management features can facilitate campaign management by increasing the workflow link between performance of keywords, placements, or subgroups of the keywords or placements, and campaign management. Thus, the advertiser can select a keyword, placement, or subgroup of a keyword or placement, and immediately see the performance of the selected keyword, placement, or subgroup of a keyword or placement. The advertiser can effect changes to an advertising campaign while reviewing the performance data through an editable performance report. Such implementations can decrease the likelihood that an advertiser might mistakenly change the attributes of the wrong keyword, placement, or subgroup thereof that often occurs when the advertiser uses a separate management tool and reporting tool.

Although the examples used herein focus on placements, the features and functions described below can also be applied to keywords.

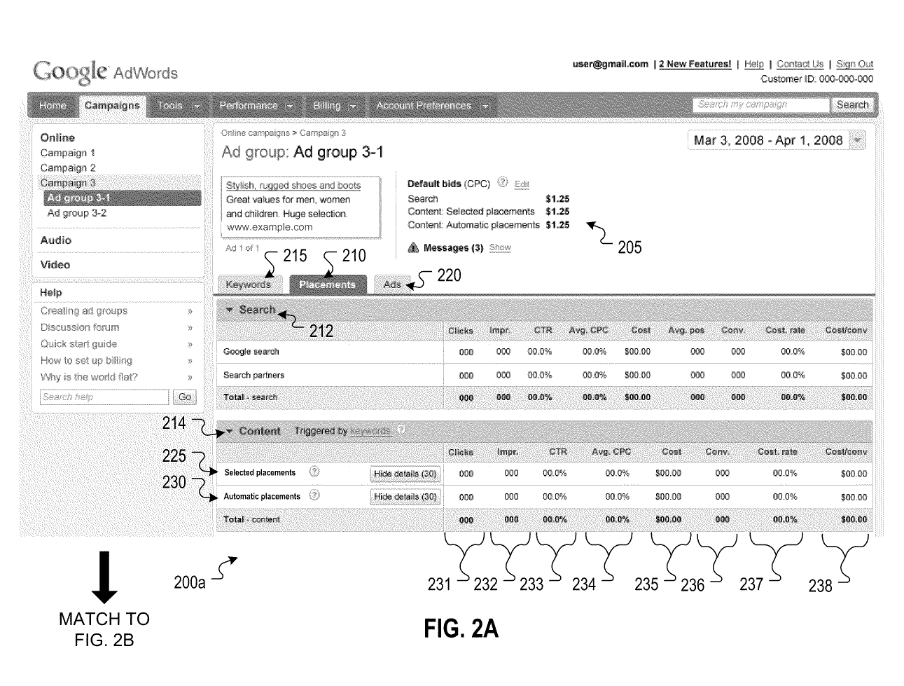

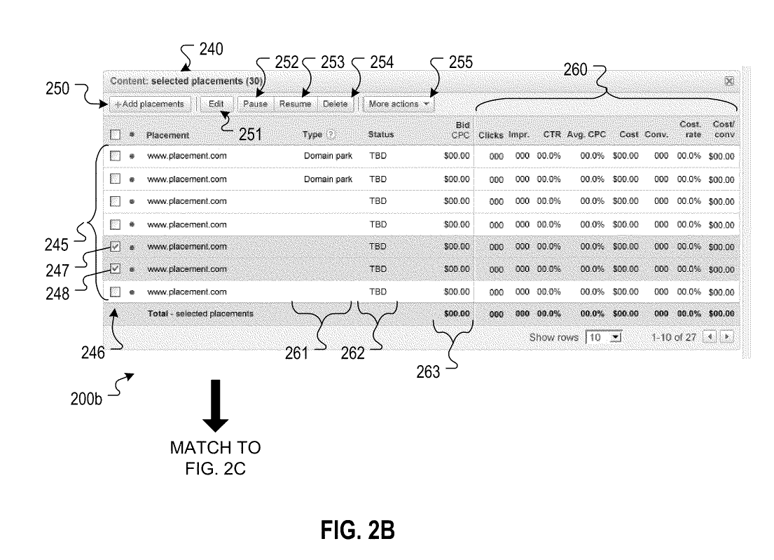

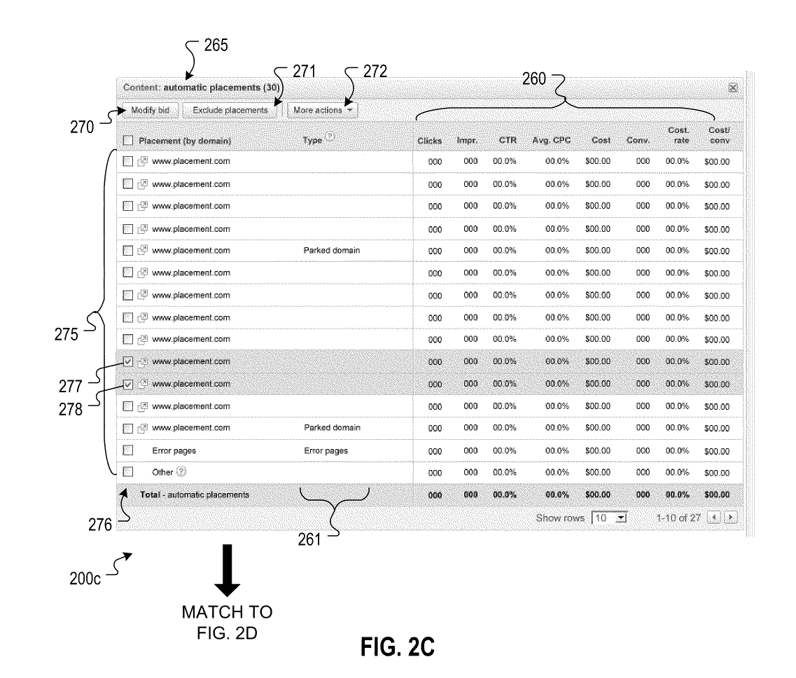

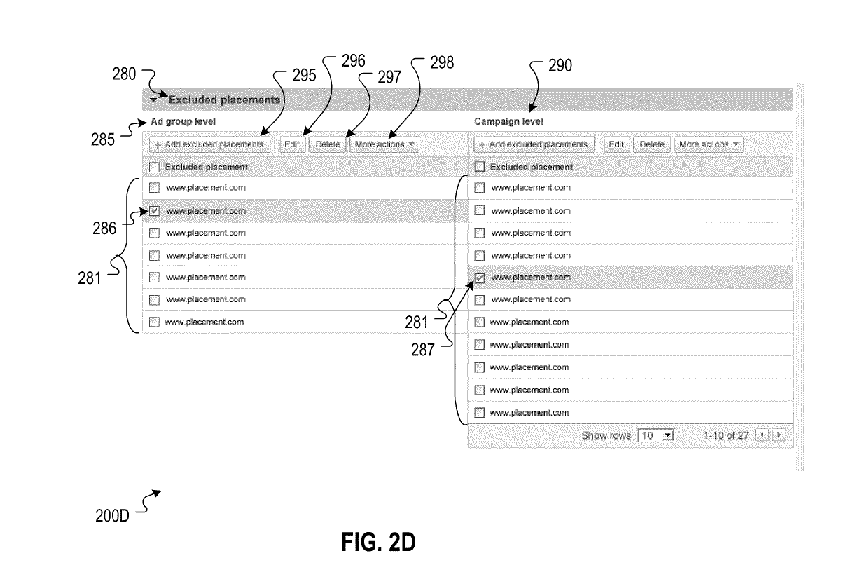

FIGS. 2A-D are screen shot representations of an example integrated campaign management interface 200A-D. The screen shots correspond to a campaign management interface displayed on a user device. The advertising management system 104 can provide campaign management interface data that causes the user device to display the campaign management interface. Examples of such data include HTML pages and JavaScript instructions. The campaign management interface includes a plurality of row and each of the rows correspond to a placement specified in an advertising campaign. The rows have a plurality of fields in which performance data associated with each placement is displayed, and in which campaign data associated with a campaign is also displayed. The campaign management interface can facilitate editing of the campaign data, as described below.

Each screen shot representations provided in FIGS. 2A-D is an interface section that is provided in a singular web page environment, and the advertiser accesses each screen by scrolling down through the web page, as indicated by the matching of FIGS. 2A to 2B, 2B to 2C, and 2C to 2D.

The integrated campaign management interface 200A can include an indication of default bids 205 associated with the advertisement or advertising campaign. The bids and placements can, for example, be specified by the campaign data. In the example of FIGS. 2A-D, a “Placements” tab representation 210 is selected. The “Placements” tab representation 210 can provide information related to placements (i.e., websites) on which the advertiser would like the advertisement or advertising campaign to run. In the implementation shown, the placements of FIGS. 2A-2D are aggregated at the domain level. Note that although each placement is listed as “www.placement.com” in the example screen shots, it is to be understood that each row corresponds to a separate and unique placement, i.e., a different domain name or site.

The integrated campaign management interface 200A can also include a “Keywords” tab representation 215, and an “Ads” tab representation 220. The “Keywords” tab representation can show similar information to the “Placements” tab representation, except that the placement URLs are replaced with keywords. The “Ads” tab representation 220 can facilitate review by the advertiser of the advertisements and being run in a campaign and their respective performance.

In some implementations, the integrated campaign management interface 200A can include a “Search” summary representation 212, and a “Content” summary representation 214. The “Search” summary representation 212 can include a summary of the performance of the advertisement or campaign in search related slots provided by the search engine 112 and other search entities. The “Content” summary representation 214 can include a summary of the performance of the advertisement or campaign when the placements are publisher sites 106.

The placement summary information can be broken down into “Selected placements” 225 and “Automatic placements” 230. Selected placements are those placements, which are selected by the advertiser for inclusion in the campaign. Automatic placements are those placements, which are selected by the advertising management system 104 as being similar to the demographics, or other information associated with or selected by the advertiser.

In some implementations, the summary representation 212 can provide performance data. The performance data can include, for example: a “Clicks” representation 231, identifying the number of clicks an advertisement or campaign has received; an “Impressions” representation 232, identifying the number of impressions an advertisement or campaign has received; a “CTR” representation 233, identifying a click-through rate associated with the advertisement or campaign; an “Average cost-per-click” representation 234, identifying the average cost-per-click associated with the advertisement or campaign; a “Cost” representation 235, identifying the total cost of a the placements; a “Conversions” representation 236, identifying the number of conversions an advertisement or campaign has received; a “Conversion Rate” a conversion rate associated with the advertisement or campaign; and a “Cost/Conversion” representation, identifying the cost per conversion associated with the advertisement or campaign.

FIG. 2B is a screen shot representation of a second part of the integrated campaign management interface 200B. The integrated campaign management interface 200B identifies a selected placements summary portion 240 of the interface 200A-D. The selected placements summary portion 240 of the interface 200A-D can include a listing of a plurality of selected placements 245, which have been selected by the user for inclusion in the campaign. The advertiser can use checkbox representations 246 associated with the placements 245 to perform actions on the placements, of which checkboxes 247 and 248 are selected.

Example button commands include an “Add placements” button representation 250; an “Edit” button representation 251; a “Pause” button representation 252; a “Resume” button representation 253; a “Delete” button representation 254; and a “More actions” drop down menu button representation 255. The Add placements button representation 250 can be selected to add new placements to the selected placements 245. The remaining buttons can be used to change the status of a selected placement 245 with selected checkboxes, e.g., the placements with selected checkboxes 247 and 248. For example, editing bid parameters associated with a selected placement, changing the status of bidding on the selected placement to paused or active, or deleting the selected placement the list of selected placements 245 can be facilitated by the selection of buttons 251, 252, 253 and 254, respectively. In particular, the “Edit” button representation 251 can be used to facilitate editing of placements having a selected checkbox representation 247, 248. The “Pause” button representation 252 can pause the inclusion of the advertisement participation with placements having a selected checkbox representation 247, 248. The “Resume” button representation 253 can resume participation of the advertisement in placements that were previously paused. The “Delete” button representation 254 can remove a placement having a selected checkbox representation 247, 248 from the list of selected placements 245. The “More Actions” button representation 255 can facilitate other actions provided by the integrated campaign management interface 200B.

The integrated campaign management interface 200B can also include performance data 260 (described above), placement type data 261, status information, and bid information associated with the respective placements 245. The placement type data 261 can identify a type associated with the respective placement. The status information 262 can identify a status associated with the placement (e.g., active, paused, etc.). The bid information 263 can identify a bid associated with the respective placement. As shown, the bids information 263 identifies a bid that the advertiser has bid for each respective placement.

FIG. 2C is a screen shot representation of a third portion of the integrated campaign management interface 200C. The third portion of the integrated campaign management interface 200C can provide an automatic placements summary portion 265 of the interface 200A-D, identifying placements the advertisement or campaign automatically selected by an advertising management system. The automatic placements summary portion 265 of the interface 200A-D can include, for example: a “Modify bid” button representation 270; an “Exclude placement” button representation 271; and a “More actions” drop down menu button representation 272. The automatic placements summary portion 265 of the interface 200A-D can also include a listing of placements 275 automatically selected by an advertising management system. The advertiser can perform an action on any of the placements 275 by selecting the placements using checkbox representations 274 associated with the placement. As shown, checkbox representations 277 and 278 have been selected.

The “Modify Bid” button representation 270 can facilitate the modification of a default bid or the addition of a specific bid for placements having a selected checkbox representation 277, 278. The “Exclude Placements” button representation 271 can facilitate the addition of placements having a selected checkbox representation 277, 278 to a list of excluded placements. The “More Actions” button representation 335 can facilitate other actions provided by the integrated campaign management interface 300b.

The automatic placements summary portion 265 of the interface can also include performance data 260 and placement type data 261, while excluding the status and bid information, because the placement is an automatic placement. As the advertiser has not selected these placements, advertisements may be shown on the placements if the placement meet one or more predefined criteria (e.g., demographics associated with the campaign, and content keywords) and based on a default keyword bid provided by the advertiser.

FIG. 2D is a screen shot representation of a fourth portion of the integrated campaign management interface 200C. The fourth portion of the integrated campaign management interface 200D can provide excluded placements summary portion 280 of the interface 200A-D. In some implementations, the excluded placements summary portion 280 of the interface 200A-D can separate the exclusions into “Ad group level” exclusions 285 and “Campaign level” exclusions 290. The advertiser can perform actions on the exclusions by selecting excluded placements using checkbox representations 281. As shown, checkboxes 286 and 287 are selected. The particular action to be performed on the selected excluded placement indicated by the checkboxes 286 and 287 can be selected using button representations 295-298. The actions can include, for example: adding the excluded placement to the selected placement list, editing the excluded placement, or deleting the excluded placement, among others.

### § 3.0 Example Features of an Integrated Campaign Management Interface

From the automatic placements summary portion 265 of the interface 200A-D, the advertiser can select specific placements it would like to add to the selected placements of FIG. 2B, or add to the excluded placements of FIG. 2D, edit placements, and run placement reports.

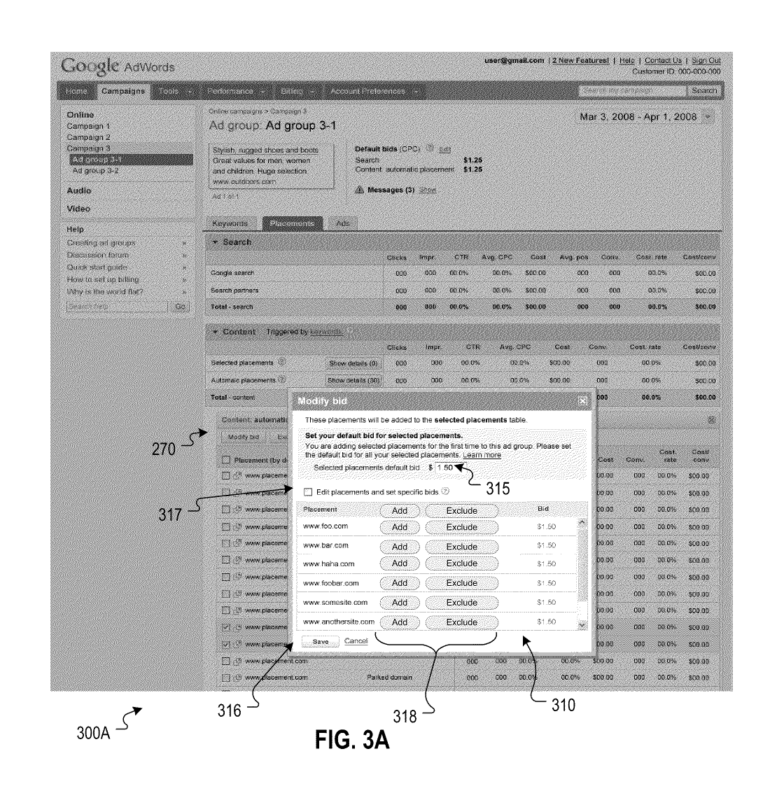

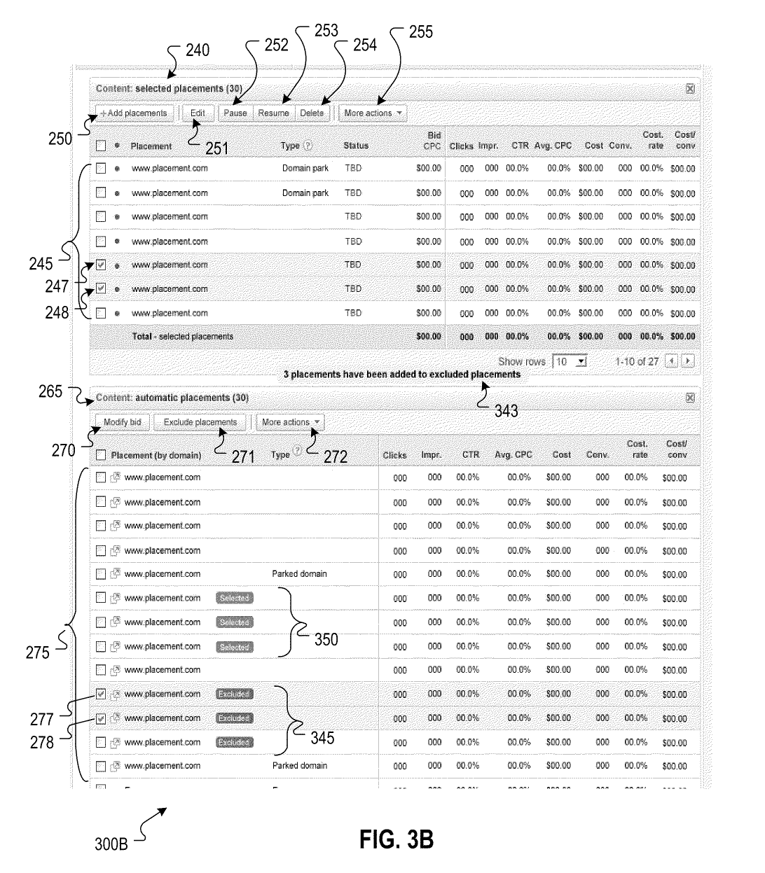

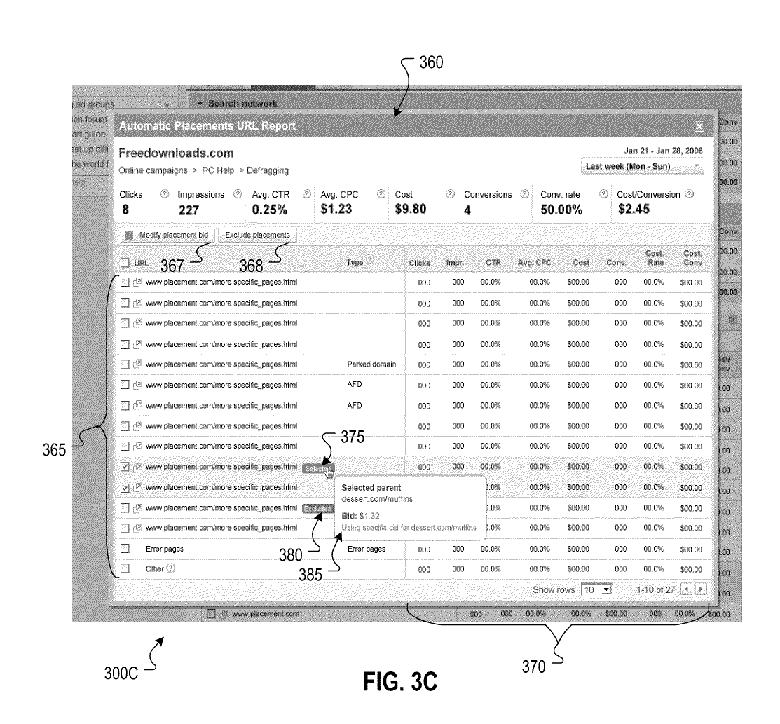

FIGS. 3A-C are screen shot representations illustrating such actions. FIG. 3A is an example screen shot representation of an integrated campaign management interface 300A including a bid modification pop-up representation 310. The bid modification pop-up representation 310 can be provided to the advertiser as a result of the advertiser selecting a “Modify Bid” button representation 270 (e.g., button representation 270 of FIG. 2C) from within an integrated campaign management representation 300A, or in response to adding a placement from the automatic placements to the selected placements. As described above, “Selected Placements” are those that have been selected by the advertiser. In some implementations, selected placements can be distinguished from automatic placements through the presence of a user modified bid (e.g., automatic placements can use a single default bids to identify placements).

The bid modification pop-up representation 310 can facilitate the advertiser modifying a bid for selected placements using a bid modification field representation 315. Entry of a bid into the bid modification field representation 315 and selection of a “Save” button representation 316 can cause the pop-up representation 310 to effect changes to the bid associated with the selected placements (or keywords if keywords are selected).

In some implementations, the pop-up representation 310 can also include a checkbox representation 317 to edit placements and set specific bids for each placement. For example, if an advertiser would like to eliminate a placement from the automatic placements group or add a placement from the automatic placements group, the advertiser can select the checkbox representation 317 to make the placements editable, and the “Add” and “Exclude” command buttons 318 become visible and operative. In another example, if an advertiser would like to set a specific bid for a placement, the advertiser can select the checkbox representation 317 to make the bid field associated with the placement(s) editable, and the advertiser may edit each bid separately.

FIG. 3B is an example screen shot representation of an integrated campaign management interface being used to add placements from the automatic placements 275 to the list of selected placements 245 or to add placements to the list(s) of excluded placements.

In the example of FIG. 3B, three placements are being added to the list of excluded placements. In this example, the advertiser has previously added one placement to the list of excluded placements during this session, and has selected two more placements for addition to the excluded placements by marking the checkbox representations 277, 278. The advertiser has also selected the “Exclude Placements” button representation 271 to add the marked placements to the list of excluded placements. A notification 343 can be provided indicating the number of placements added to the list of excluded placements. In some implementations, the placements added to the list of excluded placements during the session can be marked with a red “Excluded” field representation 345, and the placements added to the list of selected placements during the session can be marked with a green “Selected” field representation 350.

FIG. 3C is an example screen shot representation of a performance placement report representation 360 for a placement (or keyword) provided within the campaign management interface. The placement report can be run in response to receiving a request to run a placement for a particular placement. The request can be generated at the client device in a variety of ways, e.g., in response to a right-click of a selected placement, or in response to a selection of a report command that may be generated as a drop down command from one of the “More actions” buttons 255 or 272.

In response to receiving a request to provide placement report data for a selected placement, the integrated campaign and performance reporting and management module 150 can generate placement report data specifying a campaign performance of the placement according to a plurality of subgroups of placements. Each subgroup belongs to the selected placement. The placement report data causes the user device to display a placement report within the campaign management interface. The placement report includes a plurality of rows, and each row corresponds to a subgroup and has a plurality of fields in which performance data corresponding to only that subgroup is displayed.

In some implementations, the report is a modal format that opens as an overlay. In other implementations, the report can be generated in-line as a set of rows that are subordinate (e.g., indented) to the row of the placement for which the report is generated.

In some implementations, the performance placement report representation 360 can include a plurality of subgroups 365 of placements associated with a placement and performance data 370 associated with each of the subgroups. The subgroups of placements can include, for example, different pages within a website associated with a domain name, or subdomains within the domain name. Actions can be initiated with respect to the subgroups 365 by selection of a checkbox representation 366 and a button representation 367 and 368. The button representations 367 and 368 can correspond to, for example, a modification command, such as a “Modify placement bid” button representation 367, and an exclusion command, such as an “Exclude placements” button representation 368. The “Modify placement bid” button representation 367 can facilitate modification of a bid associated with a selected subgroup of the placement or keyword. The “Exclude placements” button representation 368 can facilitate exclusion of the advertisement from participation in auctions associated with a subgroup of placements or keywords. In some implementations, modification of a bid for a subgroup of placement or keywords can add the subgroup of placements or keywords to a selected placements or keywords, and can be marked by a “Selected” button representation 375. Excluded subgroups of placements can be marked with an “Excluded” button representation 380. In some implementations, when the “Selected” or “Excluded” button representations 375 and 380, respectively, are hovered over with a mouse pointer representation, a popup representation 385 can display information associated with the selected or excluded placement.

### § 4.0 Example Campaign Editing Processes

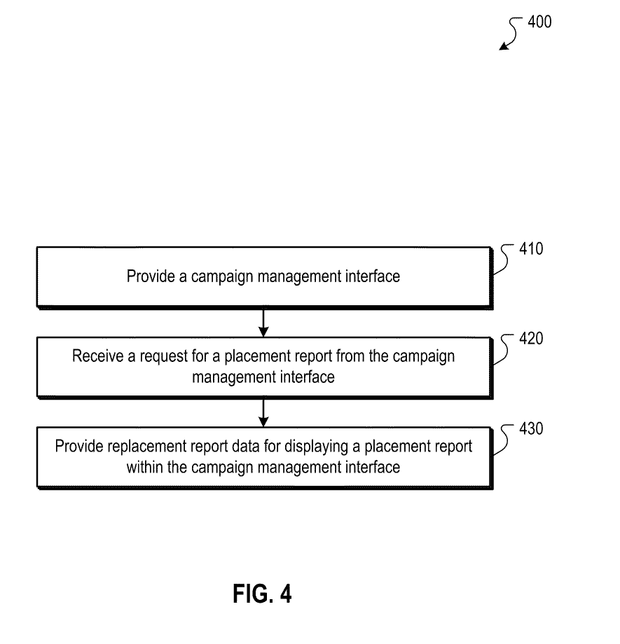

FIG. 4 is a flowchart of an example method 400 for providing an integrated campaign management interface. At stage 410, a campaign management interface is provided. The campaign management interface can be generated and provided, for example, by an integrated campaign performance reporting and management module (e.g., integrated campaign performance reporting and management module 150 of FIG. 1). The campaign management interface can include the ability to manage advertisements and ad campaigns by selecting placements, excluding placements, and reviewing automatic placements. The campaign management interface can also facilitate modification of specific bids for selected placements and modification of default bids for automatic placements. The campaign management interface can also enable the advertiser to pause and resume placements.

At stage 420, a request for a placement report from the campaign management interface is received. The request can be received, for example, through an integrated campaign management interface displayed on a user device. The placement report can be a report for a placement that includes subgroups of placements. The integrated campaign performance reporting and management module 150 can generate placement report data can that specifies the campaign performance of the placement according to a plurality of subgroups, each subgroup belonging to the selected placement, and which causes the user device to display a placement report within the campaign management interface. The placement report can include a plurality of rows, each row corresponding to a subgroup and having a plurality of fields in which performance data corresponding to only that subgroup is displayed.

At stage 430, the replacement report data for displaying a placement report within the campaign management interface is provided. For example, the integrated campaign performance reporting and management module 150 can provide the placement report to the requesting user device in response to the request for the placement report.

In some implementations, the expansion of the keyword or placement into subgroups can also facilitate editing of the subgroup for the keyword or placement from within the campaign management interface. Editing the subgroup for the keyword or placement from within the campaign management interface can include editing bidding information associated with the keyword or placement, or subgroup of the keyword or placement. Editing the advertisement or campaign from within an integrated campaign management interface can also reduce transcription errors from interpretation of performance data from one interface to editing the associated placement or keyword data in a separate interface. For example, if an advertiser were using two separate interfaces, one for campaign management and another for performance reporting, the advertiser might misinterpret performance data for one placement or keyword as applying to a different placement or keyword and make changes to the wrong placement or keyword in the campaign management interface.

### § 5.0 Example Computer System

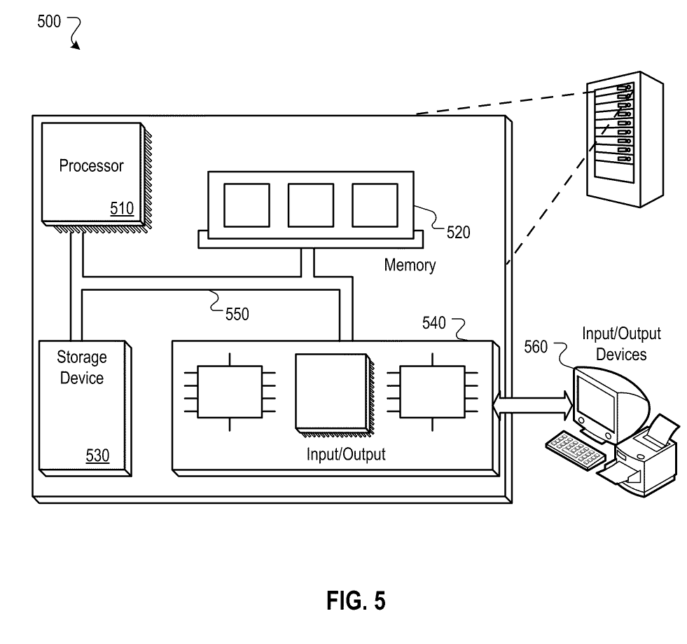

FIG. 5 is block diagram of an example computer system 500. The system 500 includes a processor 510, a memory 520, a storage device 530, and an input/output device 540. Each of the components 510, 520, 530, and 540 can, for example, be interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can, for example, include a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

The advertising management system 104 and/or integrated campaign performance reporting and management module 150, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium. The advertising management system 104 and/or integrated campaign performance reporting and management module 150, and components thereof, can be distributively implemented over a network, such as a server farm, or can be implemented in a single computer device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server/data processing apparatus, or that includes a middleware component, e.g., an application server, or that includes a front end component, e.g., a client computer/data processing apparatus having a graphical user interface or a Web browser through which a user can interact with an implementation of the subject matter described is this specification, or any combination of one or more such back end, middleware, or front end components.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
generating at a data processing apparatus campaign management interface data that causes a user device to display a campaign management interface, the campaign management interface comprising a plurality of rows, each of the rows corresponding to a placement specified in an advertising campaign, the rows having a plurality of fields, the campaign management interface being operable to display performance data associated with each placement and to display campaign data associated with a campaign in the plurality of fields and facilitate editing of the campaign data;
providing the camping management interface data to the user device;
receiving at the data processing apparatus a request to provide placement report data for a selected placement, the placement report data specifying a campaign performance of the placement according to a plurality of subgroups, each subgroup belonging to the selected placement, and which causes the user device to display a placement report within the campaign management interface, the placement report comprising a plurality of rows, each row corresponding to a subgroup and having a plurality of fields in which performance data corresponding to only that subgroup is displayed;
generating at the data processing apparatus the placement report data; and
providing the placement report data to the user device.

2. The computer-implemented method of claim 1, wherein the request to provide placement report data includes a request to exclude a selected subgroup of the placement; and
wherein generating the placement report data comprises generating placement report data that does not include placement report data corresponding to the selected subgroup of the placement.

3. The computer-implemented method of claim 1, wherein the placement report data is further operable to cause the user device to display the placement report in an overlay.

4. The computer-implemented method of claim 1, wherein the placement report data is further operable to cause the user device to display the placement report in the campaign management interface subordinate to a row corresponding to the selected placement.

5. The computer-implemented method of claim 1, wherein the placement report data is further operable to cause the placement report to include a plurality of commands, the commands including a modification command within the placement report that is operable to enable modification of a bid from within the placement report, the bid being associated with a selected subgroup.

6. The computer-implemented method of claim 1, wherein the placement report data is further operable to cause the placement report to include a plurality of commands, the commands including an exclusion command within the placement report that is operable to exclude a selected subgroup from a campaign.

7. The computer-implemented method of claim 1, wherein each row in the campaign management interface corresponds to a domain, and each subgroup in the placement report corresponds to a web page within a domain.

8. The computer-implemented method of claim 1, wherein the performance data includes one or more of a number of clicks, a number of impressions, a click through rate, an average cost per click, a number of conversions, or a cost per conversion.

9. A system, comprising:
a data processing apparatus; and
a data store storing instructions executable by the data processing apparatus and operable to cause the data processing apparatus to perform operations comprising:
generating campaign management interface data that causes a user device to display a campaign management interface, the campaign management interface comprising a plurality of rows, each of the rows corresponding to a placement specified in an advertising campaign, the rows having a plurality of fields, the campaign management interface being operable to display performance data associated with each placement and to display campaign data associated with a campaign in the plurality of fields and facilitate editing of the campaign data;
providing the campaign management interface data to the user device;
receiving a request to provide placement report data for a selected placement, the placement report data specifying a campaign performance of the placement according to a plurality of subgroups, each subgroup belonging to the selected placement, and which causes the user device to display a placement report within the campaign management interface, the placement report comprising a plurality of rows, each row corresponding to a subgroup and having a plurality of fields in which performance data corresponding to only that subgroup is displayed;
generating the placement report data; and
providing the placement report data to the user device.

10. The system of claim 9, wherein the request to provide placement report data includes a request to exclude a selected subgroup of the placement; and
wherein generating the placement report data comprises generating placement report data that does not include placement report data corresponding to the selected subgroup of the placement.

11. The system of claim 9, wherein the placement report data is further operable to cause the user device to display the placement report in an overlay.

12. The system of claim 9, wherein the placement report data is further operable to cause the user device to display the placement report in the campaign management interface subordinate to a row corresponding to the selected placement.

13. The system of claim 9, wherein the placement report data is further operable to cause the placement report to include a plurality of commands, the commands including a modification command within the placement report that is operable to enable modification of a bid from within the placement report, the bid being associated with a selected subgroup.

14. The system of claim 9, wherein the placement report data is further operable to cause the placement report to include a plurality of commands, the commands including an exclusion command within the placement report that is operable to exclude a selected subgroup from a campaign.

15. The system of claim 9, wherein each row in the campaign management interface corresponds to a domain, and each subgroup in the placement report corresponds to a web page within a domain.

16. A computer-implemented method, comprising:
receiving campaign management interface data at a user device, the campaign management interface data operable to cause the user device to display a campaign management interface, the campaign management interface comprising a plurality of rows, each of the rows corresponding to a placement specified in an advertising campaign, the rows having a plurality of fields, the campaign management interface being operable to display performance data associated with each placement and to display campaign data associated with a campaign in the plurality of fields and facilitate editing of the campaign data;
displaying the campaign management interface at the user device;
sending a request to an advertisement system from the user device, the request being a request to provide placement report data for a selected placement, the placement report data specifying a campaign performance of the placement according to a plurality of subgroups, each subgroup belonging to the selected placement, and which causes the user device to display a placement within the campaign management interface, the placement report comprising a plurality of rows, each row corresponding to a subgroup and having a plurality of fields in which performance data corresponding to only that subgroup is displayed;
receiving the placement report data at the user device; and
displaying the placement report at the user device.

17. The computer-implemented method of claim 16, wherein the placement report includes a plurality of commands, the commands including a modification command within the placement report that is operable to enable modification of a bid from within the placement report, the bid being associated with a selected subgroup.

18. The computer-implemented method of claim 16, wherein the placement report includes a plurality of commands, the commands including an exclusion command within the placement report that is operable to exclude a selected subgroup from a campaign.

19. The computer-implemented method of claim 16, wherein each row in the campaign management interface corresponds to a domain, and each subgroup in the placement report corresponds to a web page within a domain.
